(19) United States
(12) Patent Application Publication
(10) Pub. No.: US 2002/0178251 A1
(43) Pub. Date: Nov. 28, 2002

(54) Method and agents for processing event signals

(75) Inventors: Martin Takats, Berlin (DE); Willi Paschelke, Bergfelde (DE); Axel Pauli, Berlin (DE)

Correspondence Address: SUGHRUE MION, PLLC, 2100 PENNSYLVANIA AVENUE, N.W., WASHINGTON, DC, 20037, US

(73) Assignee: ALCATEL

(21) Appl. No.: 10/140,202

(22) Filed: May 8, 2002

(30) Foreign Application Priority Data
May 22, 2001 (EP) 01 440 143.4

(51) Int. Cl. G06F 15/173; G06F 9/46

(52) U.S. Cl. 709/223; 709/318

(57) ABSTRACT

The present invention relates to a method for processing, by means of an event-processing agent of the network management system, items of event information that are signalled by network elements of a communications network to a network management system managing said communications network, and also to an event-processing agent for this purpose and a subagent for this purpose.

In the method, the processing agent starts, on the basis of at least one criterion, a first and at least one second subagent for processing first and second items of event information, respectively, and receives the first and second items of event information and forwards them to the first or at least one second subagent for processing.

### BACKGROUND OF THE INVENTION

The invention is bases on a priority application EP 01 440 143.4 which is hereby incorporated by reference.

The present invention relates to a method for processing, by means of an event-processing agent of the network management system, items of event information that are signalled by network elements of a communications network to a network management system that manages it, an event-processing agent for this purpose and also subagents for this purpose.

Communications networks, for example computer networks or telecommunications networks, are monitored and controlled by network management systems. Network elements of a communications network, for example switching centres, routers, remote equipment or the like, transmit items of event information to the network management system that manages them. In the latter, one or more processing agents, for example processing processes executed by the respective network management system, are provided that process the respective items of event information. The items of event information may, for example, be a malfunction in the managed network element or the transgression of a limit value, that is to say, for example, alarm signals, or status signals, for example the change in the configuration state of the managed network element. The processing agent writes the item of event information, for example, into a database from which it is read out, for example, by an operating interface of the network management system. The event database then reflects, for example, the event state of the managed network element.

In known network management systems, a processing agent is responsible, for example, for all the alarm signals that are transmitted by one or more network elements. The processing agent is started on the basis of a configuration file during the system start of the network management system and is, so to speak, the response partner for one or more managed network elements during the running time of the network management system. The processing agent must therefore be designed in such a way that it can process all the types of items of event information that are transmitted by the network element it manages. If, however, something changes in the configuration of the network element, for example because a new software is loaded, the processing agent may possibly not process, because of the new software version, newly added items of event information and/or items of event information that have been altered compared with the old software version in content or with regard to formatting.

A further problematic situation occurs if a processing agent that is already responsible for one or more network elements is to process items of event information of a further network element and is thereby overloaded.

### SUMMARY OF THE INVENTION

The object of the invention is therefore to provide optimized event information processing in a network management system.

This object is achieved by a method for processing, by means of an event-processing agent of the network management system, items of event information that are signalled by network elements of a communications network to a network management system managing said communications network,

starting the processing agent starts, on the basis of at least one criterion, a first subagent and at least one second subagent for processing first and second items of event information, respectively, and

the processing agent or a communications agent receiving the first or second items of event information and forwards them to the first or at least one second subagent, respectively, for processing.

A event-processing agent of a network management system for processing items of event information that are signalled by network elements of a communications network to a network management system that manages said communications network,

having starting means that are configured in such a way that it can start, on the basis of at least one criterion, a first and at least one second subagent for processing first and second items of event information, respectively, and

having transmitting and receiving means that are configured in such a way that it can receive the first and second items of event information, respectively, and forward them to the first or at least one second subagent, respectively, for processing and also

event-processing agent of a network management system for processing items of event information that are signalled by network elements of a communications network to a network management system that manages said communications network, wherein

having starting means that are configured in such a way that it can start, on the basis of at least one criterion, a first and at least one second subagent for processing first and second items of event information, respectively, and it can evaluate a different quality of the first and the second items of event information and/or a load limit of the first and/or of the at least one second subagent and/or the respective source of the first and of the second items of event information as the at least one criterion, and

it has transmitting and receiving means that are configured in such a way that it can receive the first and second items of event information, respectively, and forward them to the first or at least one second subagent, respectively, for processing.

The invention is based on the idea that the processing agent or a communications agent at a central point receives the items of event information transmitted by one or more network elements. However, the actual processing of the items of event information is taken over by one or more subagents that are optimally suited to processing the respective items of event information. For example, a first subagent may be provided to process items of event information of a first network element and a second subagent for processing items of event information of a second network element. Furthermore, the processing agent or the communications agent may be the central response partner for further agents of the network management system. For example, an operating interface agent that is provided for generating an operating interface of the network management system may call up items of event information from the processing agent or the communications agent. For the operating interface agent, the fact that subagents undertake the actual processing of the items of event information, for example the entry into an event database, remains hidden. In this connection, it is also possible that a controlled and monitored calling-up subagent is provided by the processing agent for calling up items of event information, for example by the operating interface agent. In principle it is possible that a processing agent operates a plurality of subagents in parallel or, for example, only one subagent that it optionally replaces by a replacement subagent. The subagents, that is to say the original subagent and the replacement subagent may, in the latter case, be active one after another or also active in parallel for a transition phase.

The forwarding of items of event information and/or of requests to the subagents can be undertaken by the processing agent(s). However, one or more communications agents may also be provided for this purpose.

At any rate, the concept of the subagents makes it possible to adapt dynamically the network management system to the respective system requirements, for example number and/or operating characteristics of the managed network elements.

Advantageous refinements of the invention are to be found in the subclaims and also in the description.

To decide which and/or how many subagents are suitable for processing the items of event information, the processing agent may proceed according to one or more criteria, of which a few are mentioned by way of example below:

Expediently, the processing agent in each case starts those subagents that are optimally matched to the quality of the respective item of event information to be processed. For example, a first subagent may be provided for processing items of event information of a first type and a second subagent for processing items of event information of a second type.

Furthermore, it is possible that the processing agent takes account of the respective load limit of a subagent in regard to items of event information to be processed. For example, if the load limit of a first subagent is reached, a second subagent can be started by the processing agent. If the load drops below the limit again, the second subagent can be terminated. The load limit may be exceeded, for example, in that a subagent can be responsible only for a predetermined number of network elements, for example two network elements. A load limit may, however, also be exceeded temporarily, for example if a multiplicity of items of event information is to be processed in the case of a malfunction.

As a further criterion, an individual assignment of one or more network elements to subagents may be provided in each case.

A further advantage of the concept according to the invention emerges in the event of an alteration of the configuration of the communications network managed by the network management system and/or of the configuration of network elements of the communications network. The processing agent can respond dynamically to such alterations and, in doing so, advantageously start new subagents that are responsible, for example, for newly added network elements, and/or terminate subagents if a network element is removed from the managed communications network, for example when its operation is terminated. An adaptation to local alterations, for example if a network element with altered configuration data is operated and/or the network element is operated with a new software, is also readily possible: the processing agent transmits to the subagent or subagents responsible for the respective network element, for example, control data with which the latter are adapted to the new conditions in the case of the managed network element. It is also possible for the processing agent to start one or more new subagents that replace or supplement the subagent or subagents responsible since then for the managed network element.

Advantageously, provision is made for the processing agent to monitor the serviceability of its subagents and, in the event of a functional breakdown, to initialize fault treatment. For example, the processing agent may start one or more new subagents that replace the faulty subagent.

In principle, the concept according to the invention is suitable for processing any type of items of event information. Advantageously, however, provision is made for the items of event information to be alarm signals of managed network elements.

The event-processing agent is preferably a program module that contains the program code that can be executed by a control means of a server of the network management system. In principle, however, it is also possible that the processing agent is a separate computer of a network management system. Also in regard to subagents, implementations in hardware and in software are possible in principle.

### BRIEF DESCRIPTION OF THE DRAWINGS

The invention is explained below by reference to an exemplary embodiment with the aid of the drawing. In the drawing:

FIG. 1 shows a network management system NMS according to the invention of a communications network NW comprising processing agents VO1, VO2 according to the invention and also subagents S1, S4; S21, S22, S31, S32 according to the invention,

FIG. 2 shows a diagrammatic detailed view of the processing agent VO1,

FIG. 3 shows a diagrammatic detailed view of the sub agent S1,

FIGS. 4-6 show the items of event information transmitted by network elements SW1-SW4 of the communications network NW, and

FIG. 7 shows a modification of the arrangement from FIG. 1 comprising an additional communications agent KS co-operating with a processing agent V22 provided in place of the processing agent VO2.

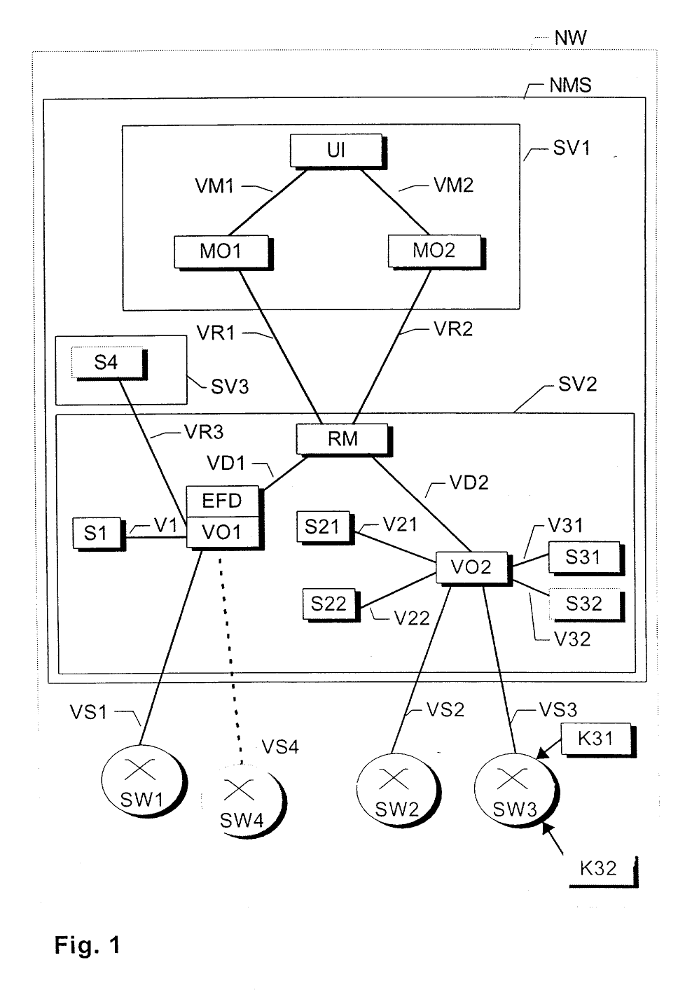

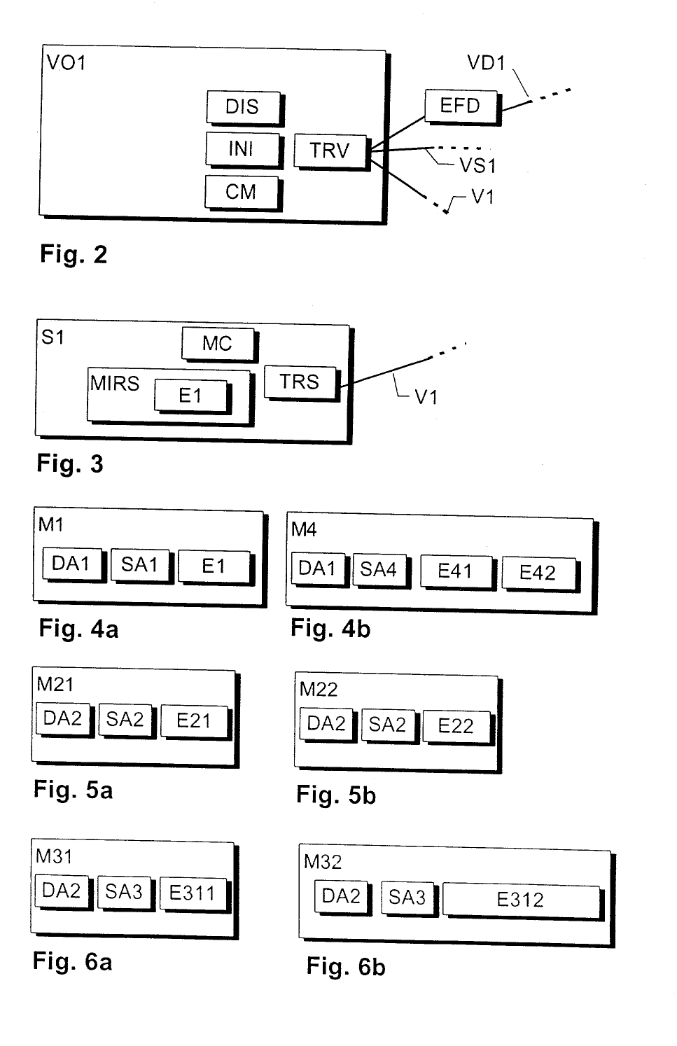

The communications network NW shown in FIG. 1 is managed by a network management system NMS comprising server SV1-SV3 and has network elements SW1-SW4 that are, for example, switching centres, routers or service computers for furnishing services of a so-called intelligent network (IN). The network management system NMS has, for example, an open system architecture and serves to manage, maintain and operate the network elements SW1-SW4 and also further network devices of the communications network NW that are not shown in the figure. The communications network NW may be either a telecommunications network, for example a telephone network or data network, or, alternatively, a local network, for example a LAN (local area network). Terminals, for example telephone terminals, personal computers or the like, that are not shown may be connected, for example, to the network elements SW1-SW4.

The network elements SW1-SW4 are sources of items of event information, for example transgression of limit values, breakdowns, items of load information or the like, that they transmit to the network management system NMS. In the latter, the items of event information are pre-processed by event-processing agents VO1, VO2. These are a process or a group of processes whose program code is executed by the server SV2. Furthermore, the processing agents VO1, VO2 also serve in the present case to control the network elements SW1-SW4. The processing agents VO1, VO2 may also be described as managed objects that represent the network elements SW1, SW4 or SW2, SW3, respectively, within the network management system NMS. At any rate, the processing agents VO1, VO2 may each represent only a sub-aspect of the network elements SW1-SW4, for example be responsible only for alarm signals transmitted by them or represent them completely within the network management system NMS.

The processing agent VO1 is responsible for the network elements SW1, SW4, while the processing agent VO2 is responsible for the network elements SW2, SW3. It is also conceivable that one processing agent is responsible in each case for each of the network elements SW1-SW4. Furthermore, a plurality of processing agents could be assigned to one resource and represent the latter variously. For example, the processing agent VO1 could represent alarms of the network element SW1 and the processing agent VO2 its measured values. In addition, the processing agents could also be formed directly by the network elements SW1, SW2, SW3, SW4 or by the processes executed by them.

To manage, to operate and maintain the processing agents VO1, VO2, management objects or management agents MO1, MO2 are provided that are designed as processes or process groups executed by the server SV1. For example, the management object MO1 may be provided to eliminate defects in the network elements SW1-SW4 and the management object MO2 to indicate their operational states at an operating interface U1 likewise executed by the server SV1.

The servers SV1-SV3, which are not shown in greater detail, are computers or computer networks that are operated by an operating system, for example Unix or Windows NT. The servers SV1-SV3 have transmitting and receiving means, for example Ethernet interface cards, modems or the like, that are suitable for transmitting and receiving data. Furthermore, memory means, for example hard disks and RAM chips, and also control means, for example in each case individual processors or clusters of processors, are provided. The control means execute, under the control of an operating system, program code sequences of program modules that are stored in the memory means. For example, they execute program codes of the operating interface U1, of the management objects MO1, MO2 and also of the processing agents VO1, VO2.

The network elements SW1, SW4 transmit items of event information to the processing agent VO1 via connections VS1 and VS4, respectively, while the network elements SW2, SW3 transmit items of event information to the processing agent VO2 via connections VS2, VS3. The items of event information are, for example, messages that relate to limit value infringements, current system load or traffic values of connections used or operated by the network elements SW1-SW4. The items of event information are, for example, transmitted as structured data, for example, with the aid of the basic encoding rules (BER) in accordance with the definitions of the International Telecommunication Union. They may, however, also be so-called object request broker objects (ORB), those, for example, in accordance with the CORBA specification (CORBA=common object request broker architecture) of the OMG (object management group) or of the DCOM specification of the Microsoft company.

During the system start of the network management system, the latter first starts the processing agent VO1, for example on the basis of configuration data and also on the basis of its program code that are stored in each case in memory means, not shown, of the server SV2. The further processes, objects or the like, for example the management objects MO1, MO2, are also started in this way. Furthermore, a request manager RM that is provided for processing requests transmitted by the management objects MO1, MO2 is provided and also a transmission filter EFD, for example a so-called event forwarding discriminator that is assigned to the processing agent VO1, are started. A start process or start agent may be provided in the servers SV1-SV3 for the start operation.

On the basis of configuration data, for example on the basis of start parameters and/or a configuration file, the processing agents VO1, VO2 determine which network elements they are responsible for. For example, the configuration data may contain the name of the respective network element, its software version, the nature of items of event information that are transmitted by the respective network element, the format of the respective items of event information, for example the structure of the messages transporting them in each case, and also further items of configuration information not shown here.

It is also possible, however, that the processing agents VO1, VO2 dynamically determine the respective configuration of the network elements, i.e. for example, that the processing agents VO1, VO2 determine for example, during the system start, the network elements for which they are responsible.

In the exemplary embodiment, the processing agent VO1 is at first responsible for the network element SW1 (the network element SW4 is still out of operation) and starts a subagent S1 for the purpose of processing items of event information transmitted by said network element. For this purpose, there is provided as start means in the processing agent VO1 a start function INI that determines, for example on the basis of the abovementioned configuration data, which type of subagent is suitable for processing the items of event information of the network element SW1 and, accordingly, activates a suitable program module as subagent S1. In addition, the start function INI may transmit to the subagent S1 start parameters or other configuration parameters that the latter requires for processing the items of event information.

Analogously, the processing agent VO2 starts the subagents S21, S22 that are provided for processing items of event information transmitted by the network element SW2 and also a subagent S31 that is provided for processing items of event information transmitted by the network element SW3. The network element SW2 transmits, in the present case, different types of items of event information, for example limit value signals and alarm signals, to the processing agent VO2. One of the respective subagents S21, S22 is responsible for one or more types of different items of event information in each case and can process them optimally.

It is also conceivable that the subagents S21, S22 execute different functions, for example that the subagent 21 enters items of event information in a protocol file, whereas the subagent S22 optionally initiates a defect treatment. With such a constellation, the processing agent VO2 can forward the same item of event information both to the subagent S21 and to the subagent S22.

The subagent S31 is provided for processing items of event information of the network element SW3, which transmits this on the basis of a currently loaded operating software K31.

In a particularly preferred embodiment of the invention, one or more subagents each keep an event database in which they enter items of event information signalled to them so that they can be called up, for example, by the management objects MO1, MO2. By way of example, an event mirror MIRS that, so to speak, reflects the event state of the network element SW1 at least partially is shown as such an event database in the case of the subagent S1.

The subagents S1, S21, S22, S31 communicate via connections V1, V21, V22 and V31, respectively, with the processing agents VO1 and VO2 respectively assigned to them. The connections V1-V31 are, for example, interprocess communications connections. In the present case, each of the subagents S1-S31 is an independent process in which resources, for example processor time and memories, are allocated individually by the operating system, not shown, of the server SV2.

Some exemplary processing sequences of items of event information by the network management system NMS operating according to the invention are explained below.

The network element SW1 transmits a message M1 having a destination address DA1 and a source address SA1 and also an item of event information E1, for example a limit value infringement, to the processing agent VO1. This receives the message M1 by means of a connecting function, for example a program function TRV, that also serves as transmitting and receiving means for receiving items of event information. A distribution function DIS, which may be incorporated in the connection function TRV, determines on the basis of a qualifier in the message M1, in the present case on the basis of the source address SA1, that the subagent S1 is responsible for processing the message M1. For this purpose, an assignment table, for example, may be provided in the processing agent VO1. At any rate, the processing agent VO1 forwards the message M1 to the subagent S1, which enters the item of event information E1 contained therein in its event mirror MIRS. In the same way, the processing agent VO1 can also receive further messages, not shown, containing items of event information of the network element SW1 and forward them for the actual event processing, in the present case for entry in the event mirror MIRS, to the subagent S1.

The functions of the processing agents VO1, that is to say the distribution function DIS, the connecting function TRV, the start function INI and the monitoring function CM may each be implemented individually or in any grouping as separate processes.

Analogously, the processing agent VO2, which forwards messages M21, M22 transmitted by the network element SW2 to the subagents S21, S22, functions similarly. Entered in both messages M21, M22 are, in each case, identical source addresses SA2 and identical destination addresses DA2. Different, however, are the items of event information E21, E22 that are contained in the messages M21, M22 and that are, for example, an alarm signal or a cyclically signalled measurement. The distribution function DIS of the processing agent VO2 determines, in this case on the basis of the source address SA2, that the subagents S21, S22 are responsible for the signals M21, M22. Furthermore, it determines, on the basis of the items of event information E21, E22, that the message M21 is to be forwarded to the subagent S21 and the message M22 is to be forwarded to the subagent S22.

In the case of a message M31 transmitted by the network element SW3, it is sufficient that the distribution function DIS reads out the source address SA3 contained therein and determines on the basis of the latter that the subagent S31 is responsible for the processing of the message M31 and, for example, enters an item of event information E311 contained therein in a protocol file.

The items of event information E1-E311 mentioned can be called up by the management objects MO1, MO2. The latter transmit appropriate requests via connections VR1 or VR2, respectively, to the request manager RM, which forwards the respective requests via connections VD1 or VD2 to the processing agents VO1 or VO2, respectively, depending on which of the processing agents VO1, VO2 is suitable for the respective request. For example, the request manager RM transmits a request relating to items of event information of the network element SW2 to the processing agent VO2. The latter then decides whether the subagent S21 and/or the subagent S22 is suitable for processing the request. The respective subagent S21, S22 then transmits the respective item of event information, for example the item of event information E21, E22, via its connecting function TRS to the processing agent VO2 for forwarding to the management objects MO1 or MO2. From the answer, the latter then generate, for example, a viewing screen display that is forwarded via connections VM1 or VM2, respectively, to the operating interface U1.

Provided in addition in the processing agent VO1 is also a transmission filter agent EFD that filters the answer messages that are generated by the processing agent VO1 or the subagent S1, respectively, that is to say checks them with regard to whether the item of information contained in the respective answer message is at all relevant for the higher-level management object MO1, MO2. Irrelevant items of information are filtered out by the transmission filter agent EFD.

The connections VR1, VR2 are routed, for example, via an LAN (local area network) that connects the servers SV1, SV2 and on which, for example, the CMIP protocol (common management information protocol) of the OSI (open systems interconnection) or the TCP/IP-based simple network management protocol (SNMP; TCP/IP=transmission control protocol/Internet protocol), which are each suitable for transporting items of management information, is used.

It is hidden from the request manager RM that the processing agents VO1, VO2 are not responsible on their own for processing the requests transmitted by the management objects MO1, MO2, but that, in addition, the subagents S1, S21, S22, S31 are active. A similar remark applies to the network elements SW1-SW4 managed by the network management system NMS. The former transmit their items of event information to the processing agents VO1, VO2, it being irrelevant for them that the subagents S1, S21, S22, S31 are responsible for the actual processing of the items of event information.

The delegation according to the invention of the processing of items of event information to subagents does not only yield, as shown, advantages in regard to an optimum adaptation of the subagents to the items of event information to be processed and also in regard to an optimum assignment of network elements and subagents respectively responsible for them, but it also yields an optimum adaptability to load conditions and also to altered circumstances in regard to the configuration of the communications network NW. This is shown below:

In the communications network NW, the network element SW4 is put into operation. It is assigned to the processing agent VO1, that is to say the processing agent VO1 is now to process the items of event information transmitted by the network element SW4 and optionally signal them to the management objects MO1, MO2. A control process that is not shown, for example the initialization process mentioned at the beginning, transmits to the processing agent VO1 data relating to the network element SW4, for example its address, the formats of items of event information transmitted by it and/or other data characterizing the network element SW4. In principle, it would now indeed be conceivable that the processing agent VO1 commissions the subagent S1 to process the items of event information transmitted by the network element SW4. However, in the present case, the subagent S1 is already burdened with processing items of event information from the network element SW1. The processing agent VO1 therefore starts a subagent 54 especially responsible for the network element SW4. In principle, this could, indeed, be configured as a program module executed by the server SV2. In the present exemplary embodiment, however, the subagent S4 is executed by the server SV3, in which adequate resources are present for this purpose. Between the processing agent VO1 and the subagent S4, a connection VR3 is set up, which may be an interprocess interface, which can be used, for example, via a so-called remote procedure call (RPC) or another interface on which, for example, communication is with the TCP/IP protocol.

It is also possible that the processing agent VO1 starts the subagent S4 because the subagent S1 does not support the format and/or the structure of the items of event information transmitted by the network element SW4. In the exemplary embodiment, the network element SW4 specifically transmits, for example, a message M4 having a destination address DA1 and a source address SA4 and also, in contrast to the message M1 transmitted by the network element SW1, not only one item of event information E1, but in each case two items of event information per message, items of event information E41, E42 in the example.

It is furthermore also possible that the network element SW4 replaces the network element SW1, for example takes over its functions. In this case, the processing agent VO1 first starts the subagent S4 for the purpose of processing the items of event information from the network element SW4 and terminates the subagent S1 if the network element SW1 is taken out of operation. Accordingly, it is not absolutely necessary that a processing agent always operates two or more subagents. On the contrary, a processing agent can also operate in each case only one subagent and, if necessary, replace it by a suitable subagent, which will be made clear using the example of the subagents S31, S32:

The processing agent first operates the subagent S31, which is optimally adapted to the operating software K31 of the network element SW3. A new operating software K32 is now put into operation in the network element SW3. As a consequence, the network element SW3 no longer transmits messages of the type of the message M31, but messages of the type of the message M32. With regard to the source and destination addresses SA3, DA2, the messages M31 and M32 are identical. In contrast to the message M31, the message M32 contains an item of event information E312 that is modified in data structure and/or in information content compared with the item of event information E311 and that contains, for example, in addition a measurement that can be determined by means of the operating software K32. In the exemplary embodiment, the subagent S32, but not the subagent S31, can indeed process the item of event information E312.

The reloading of the operating software K32 is communicated to the processing agent VO2, for example, by the central initialization process and/or control process, not shown, of the network management system NMS. The latter then starts the subagent S32, with which it communicates via the connection V32 and which is suitable for processing messages of the type of the message M32. The subagents S31, S32 can then be operated, for example, in parallel, in which case the subagent S31 may process messages of the type of the message M31 and the subagent S32 messages of the type of the message M32. Furthermore, it is possible that the subagent S32 replaces the subagent S31 and the subagent S31 is consequently terminated. In this connection, provision is preferably made for the processing agent VO2 to undertake a data alignment between the subagents S31, S32 and/or to initialize the subagent S32 with start data prior to the termination of the subagent S31. It is furthermore possible that the subagent S32 and/or the processing agent VO2 initiate(s), for example, a data call-up in the network element SW3 in order to ascertain its current event state in this way.

The subagents S1, S4; S21, S22, S31, S32 operate, so to speak, under the control of the processing agents VO1, VO2. Said control may in principle be restricted to the processing agents VO1, VO2 starting the subagents S1, S4; S21, S22, S31, S32 and, if necessary, terminating them. The processing agents VO1, VO2 may transmit a command for the termination of a subagent S1, S4; S21, S22, S31, S32 to the operating system of the server SV2 and/or to the respective subagents S1, S4; S21, S22, S31, S32 to be terminated as a control command. A request that a processing agent VO1, VO2 transmits to a subagent S1, S4; S21, S22, S31, S32, for example a request to the subagent S1 to transmit the content of the event mirror MIRS, may also be such a control command.

A further control command may be a checking request that a monitoring function CM of the processing agent VO1 transmits to the subagent S1 and that is answered by its signalling function MC. The correct operation of the subagent S1 can be monitored with such a checking request. The checking request is, for example, transmitted cyclically and must be correctly answered by the subagent S1. If that is not the case, that is to say a functional breakdown occurs in the respective subagent S1, the processing agent VO1 may start a new subagent that replaces the faulty subagent S1 and/or record a defect signal and/or transmit a defect signal to the management objects MO1, MO2.

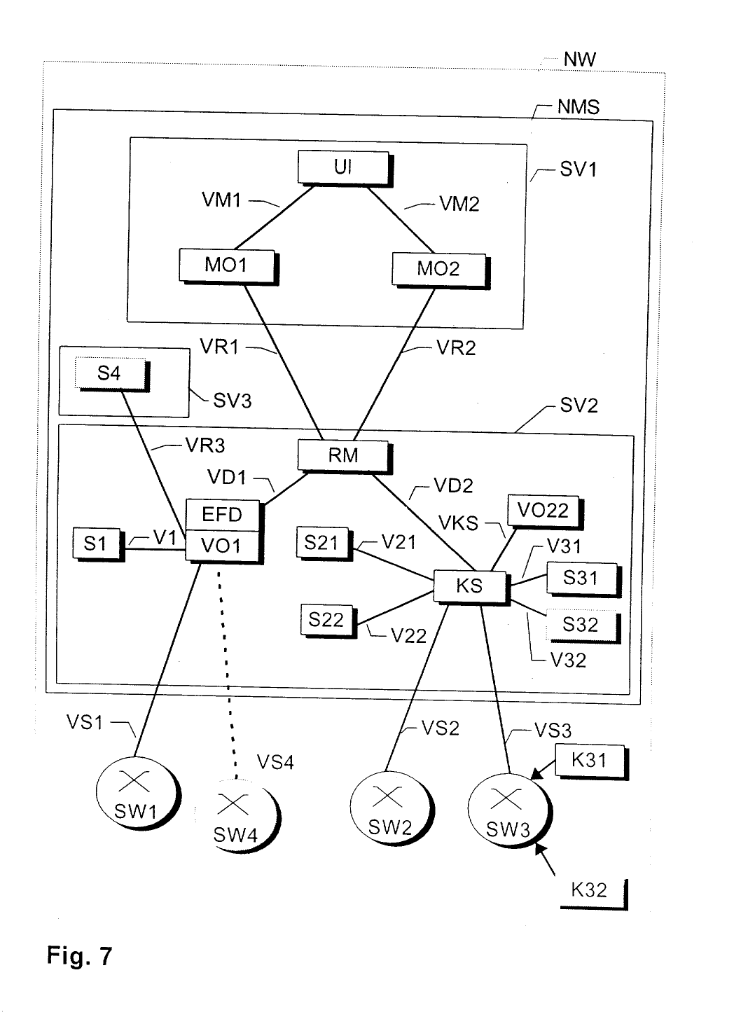

In the modification of the arrangement from FIG. 1 shown in FIG. 7, there is an additional communications agent KS that co-operates with a processing agent VO22 via a connection VKS. The processing agent VO2 substantially corresponds to the processing agent VO2, i.e. it starts and terminates the subagents S21, S22, S31, S32 in the manner described above. In contrast to the processing agent VO2, the communication between the subagents S21, S22, S31, S32, on the one hand, and the network elements SW2, SW3 and also the request manager RM, on the other hand, is not controlled by the processing agent VO22, but by the communications agent KS. The network elements SW2, SW3 therefore transmit the items of event information M21, M22; M31, M32 not to the processing agent VO22, but to the communications agent KS, which then forwards the items of event information M21, M22; M31, M32 to the respectively responsible subagents S21, S22; S31, S32. The processing agent VO22 communicates to the communications agent KS the respective configuration and/or address of the subagents S21, S22; S31, S32, for example it informs it that the subagent S31 is responsible, instead of the subagent S32, for items of event information transmitted by the network element SW3.

The communications agent KS may be a separate process executed by the server SV2 or, alternatively, a sub-process of the processing agent VO22, and consequently logically assigned to the latter.

Further variants of the invention are readily possible:

The management objects MO1, MO2 could be constructed according to the concept according to the invention and each operate one or more subagents that are each optimally matched to the items of event information to be processed, even if the communications network NW to be managed is altered.

Instead of the restart of the subagent S32, the processing agent VO2 could transmit to the subagent S31 control data with which the latter is adapted to the new operating software K32, for example control data in which the data structure of the message M32 is specified.

The subagent S32, at any rate its program code, could also be loaded into the server SV2 for the running time of the network management system NMS. At any rate, this makes it clear that the software servicing of the network management system and/or of a communications network managed by it is clearly simplified on the basis of the invention.

It goes without saying that any combinations of the measures and arrangements specified in the claims and also in the description are also possible.

1. Method for processing, by means of an event-processing agent of the network management system, items of event information that are signalled by network elements of a communications network to a network management system managing said communications network,
starting the processing agent starts, on the basis of at least one criterion, a first subagent and at least one second subagent for processing first and second items of event information, respectively, and
the processing agent or a communications agent receiving the first or second items of event information and forwards them to the first or at least one second subagent, respectively, for processing.

2. Method according to claim 1, wherein the processing agent evaluates, as the at least one criterion, a different quality of the first and of the second items of event information and/or a load limit of the first and/or of the at least one second subagent and/or the respective source of the first and of the second items of event information.

3. Method according to claim 1, wherein the processing agent ascertains an alteration in the configuration of the communications network managed by the network management system and/or of the configuration of network elements of the communications network as the at least one criterion.

4. Method according to claim 1, wherein, in the event of an alteration of the at least one criterion after starting the first and at least one second subagent, the processing agent transmits control data dependent on the criterion to the first and/or the at least one second subagent and/or terminates the first and/or the at least one second subagent and/or starts at least one third subagent.

5. Method according to claim 1, wherein the processing agent monitors the serviceability of the first and/or of the at least one second subagent and initializes a fault treatment in the event of a functional breakdown.

6. Method according to claim 1, wherein the first and/or the second items of event information of network elements contain transmitted alarm signals.

7. Event-processing agent of a network management system for processing items of event information that are signalled by network elements of a communications network to a network management system that manages said communications network,
having starting means that are configured in such a way that it can start, on the basis of at least one criterion, a first and at least one second subagent for processing first and second items of event information, respectively, and
Having transmitting and receiving means that are configured in such a way that it can receive the first and second items of event information, respectively, and forward them to the first or at least one second subagent, respectively, for processing.

8. Event-processing agent of a network management system for processing items of event information that are signalled by network elements of a communications network to a network management system that manages said communications network,
having starting means that are configured in such a way that it can start, on the basis of at least one criterion, a first and at least one second subagent for processing first and second items of event information, respectively, and evaluate the first and the second items of event information as the at least one criterion, and
having transmitting and receiving means that are configured in such a way that it can receive the first and second items of event information, respectively, and forward them to the first or at least one second subagent, respectively, for processing.

9. Event-processing agent of a network management system for processing items of event information that are signalled by network elements of a communications network to a network management system that manages said communications network, wherein
having starting means that are configured in such a way that it can start, on the basis of at least one criterion, a first and at least one second subagent for processing first and second items of event information, respectively, and it can evaluate a different quality of the first and the second items of event information and/or a load limit of the first and/or of the at least one second subagent and/or the respective source of the first and of the second items of event information as the at least one criterion, and
it has transmitting and receiving means that are configured in such a way that it can receive the first and second items of event information, respectively, and forward them to the first or at least one second subagent, respectively, for processing.

10. Subagent for processing items of event information that are signalled by network elements of a communications network to a network management system managing said communications network, wherein
the subagent has receiving means for receiving control commands that are transmitted by an event-processing agent of the network management system, and also of first and/or second items of event information that are transmitted by the event-processing agent or a communications agent of the network management system, and
the subagent has processing means for processing control commands and also the first and second items of event information respectively.

11. Memory means, in particular diskette or CD-ROM, digital versatile disk, hard disk drive mechanism or the like, comprising an event-processing agent, stored thereon, of a network management system for processing items of event information that are signalled by network elements of a communications network to a network management system managing said communications network, wherein the event processing agent contains a program code that can be executed by a control means of a server of the network management system, wherein
the event processing agent has starting means that are configured in such a way that it can start, on the basis of at least one criterion, a first and at least one second subagent for processing first or second items of event information, and
and the event processing agent has transmitting and receiving means that are configured in such a way that it can receive the first or second items of event information, respectively, and can forward them to the first or at least one second subagent, respectively, for processing.

12. Memory means, in particular diskette or CD-ROM, digital versatile disk, hard disk drive mechanism or the like, comprising an event-processing agent, stored thereon, of a network management system for processing items of event information that are signalled by network elements of a communications network to a network management system managing said communications network, wherein the event processing agent contains a program code that can be executed by a control means of a server of the network management system, wherein
the event processing agent has starting means that are configured in such a way that it can start, on the basis of at least one criterion, a first and at least one second subagent for processing first or second items of event information and it can evaluate the first and the second items of event information as the at least one criterion, and
and the event processing agent has transmitting and receiving means that are configured in such a way that it can receive the first or second items of event information, respectively, and can forward them to the first or at least one second subagent, respectively, for processing.

13. Memory means, in particular diskette or CD-ROM, digital versatile disk, hard disk drive mechanism or the like, comprising an event-processing agent, stored thereon, of a network management system for processing items of event information that are signalled by network elements of a communications network to a network management system managing said communications network, wherein the event processing agent contains a program code that can be executed by a control means of a server of the network management system, wherein
the event processing agent has starting means that are configured in such a way that it can start, on the basis of at least one criterion, a first and at least one second subagent for processing first or second items of event information and in that it can evaluate a different quality of the first and the second items of event information and/or a load limit of the first and/or of the at least one second subagent and/or the respective source of the first and of the second items of event information as the at least one criterion, and
and the event processing agent has transmitting and receiving means that are configured in such a way that it can receive the first or second items of event information, respectively, and can forward them to the first or at least one second subagent, respectively, for processing.

14. Memory means, in particular diskette or CD-ROM, digital versatile disk, hard disk drive mechanism or the like, comprising a subagent, stored thereon, for processing items of event information that are signalled by network elements of a communications network to a network management system managing said communications network, wherein the subagent contains a program code that can be executed by a control means of a server of the network management system, wherein
the subagent has receiving means for receiving control commands that are transmitted by an event-processing agent of the network management system, and also of first and/or second items of event information that are transmitted by the event-processing agent or a communications agent of the network management system, and
the subagent has processing means for processing the control commands and also the first and second items of event information respectively.

15. Server of a network management system, comprising a memory means according to claim 11, 12, 13 and/or 14 on which at least one event processing agent and/or at least one subagent is stored, and also comprising a control means for executing the at least one event processing agent or the at least one subagent, respectively.

16. Method for processing, by means of an event processing agent of the network management system, items of event information that are signalled by network elements of a communications network to a network management system managing said communications network, wherein
the processing agent starts, on the basis of at least one criterion, a first subagent and at least one second subagent for processing first and second items of event information, respectively,
and the processing agent or a communications agent receives the first or second items of event information and forwards them to the first or at least one second subagent, respectively, for processing, and
and the processing agent evaluates the first and the second items of event information as the at least one criterion.

17. Method for processing, by means of an event processing agent of the network management system, items of event information that are signalled by network elements of a communications network to a network management system managing said communications network, wherein
the processing agent starts, on the basis of at least one criterion, a first subagent and at least one second subagent for processing first and second items of event information, respectively,
and the processing agent or a communications agent receives the first or second items of event information and forwards them to the first or at least one second subagent, respectively, for processing, and
and the processing agent evaluates a different quality of the first and the second items of event information and/or a load limit of the first and/or of the at least one second subagent and/or the respective source of the first and of the second items of event information as the at least one criterion.
